(19) United States
(12) Patent Application Publication
(10) Pub. No.: US 2010/0067222 A1
(43) Pub. Date: Mar. 18, 2010

(54) Mountain Climbing Stick with Illuminating Device

(75) Inventor: Yongxiang Yu, Zhejiang (CN)

Correspondence Address: INTELLECTUAL PROPERTY LAW GROUP LLP, 12 SOUTH FIRST STREET, SUITE 1205, SAN JOSE, CA, 95113, US

(73) Assignee: Tai Pang Ng, Shatin (HK)

(21) Appl. No.: 12/513,666

(22) PCT Filed: May 23, 2007
(86) PCT No.: PCT/CN07/01677

§ 371 Date: May 5, 2009

(30) Foreign Application Priority Data
Dec. 22, 2006 (CN) 200620141403.9

(51) Int. Cl. F21L 4/00

(52) U.S. Cl. 362/158; 362/190

(57) ABSTRACT

A mountain climbing stick with an illuminating device, comprising: a shaft and a hollow handle, wherein said handle houses a battery chamber therein; a turnable cap installed at the end of said handle and said cap pivotally connected with said handle by a pivot; a lamp installed on an inside surface of the cap opposite to said shaft; a battery disposed in said handle and said lamp connected with said battery through an electric circuit. The apparatus prevents rain getting into the lamp due to a transparent cover around the lamp, a waterproof button switch is seal connected with the wiring terminal improving waterproofing, a plug socket connected with the lamp, located at the opening of the battery chamber is covered by a waterproof casing. By flipping over the turnable cap, there is illumination. To save power, the circuit is cut when the turnable cap is buckled down and attracted.

### FIELD OF THE INVENTION

Some embodiments of the invention relate to a sports apparatus, and more particularly to a mountain climbing stick with an illuminating means.

### BACKGROUND OF THE INVENTION

The applicant has previously provided a technical solution for an embodiment of a mountain climbing stick with an illuminating means in commonly owned Chinese patent application 200620103789.4 entitled “MOUNTAIN CLIMBING STICK WITH ILLUMINATING DEVICE”. The technical solution as described in the application makes use of space existing at the joint part of the handle and the shaft to mount an electric torch or an apparatus assembling a luminescent tube, a control switch and a power device together therein, so as to add an illumination function to the climbing stick and improve its application effect. However, the waterproof effect of the stick is still not so satisfied to some extent.

### BRIEF SUMMARY OF THE INVENTION

The present invention according to an embodiment provides an improved structure having an illuminating device and also having a waterproof function. The present invention provides a mountain climbing stick with an illuminating device.

The mountain climbing stick according to an embodiment of the present invention comprises a shaft and a handle, wherein a turnable cap, a pivot, a lamp together with its electric circuit, a button switch and a battery chamber are installed at the end of the handle. The lamp comprises a circuit board, a LED and a reflection cup mounted inside the turnable/rotatable cap and a transparent cover for waterproofing is installed in front of the lamp. A waterproof casing with a concave surface is installed at the position where the turnable cap is folded upon the handle. A concave chamber of the waterproof casing corresponds to the convex shape of the transparent cover. A connecting wire of the lamp is serially connected with the button switch from the lower corner of the pivot, and its lead wire is connected to a plug socket which is installed at the opening of the battery chamber and positioned by an inserting sheet. A negative contact spring leaf, which is used to connect with a negative ring of the battery rack when being plugged downward, is installed on the plug socket.

Advantageously, the battery chamber on which said plug socket and said battery rack are mounted is arranged on the top of the shaft.

Advantageously, said electric circuit also includes a boost circuit.

The present invention can prevent rain from getting into the lamp/bulb when the turnable cap is open for illumination, thus the safety of the device is ensured. The plug socket connected with the lamp is covered by the waterproof casing, and the plug socket is located at the opening of the battery chamber beneath the waterproof casing. The present invention can achieve a basic waterproof condition because of its good sealing performance. In addition, a waterproof button switch which is sealed connectedly with the wiring terminal may improve the waterproof effect of the present invention during rainy days. The advantages of the present invention also lie in a simple structure, that is practical, and easy to illuminate by turning over the turnable cap. The circuit is cut-off to save power when the turnable cap is folded closed and attracted to the handle.

### BRIEF DESCRIPTION OF THE DRAWINGS

Figures

FIG. 1 is a perspective view of the tip of the climbing stick according to an embodiment of the present invention.

FIG. 2 is a cross section of the tip of the climbing stick according to an embodiment of the present invention.

FIG. 3 is a perspective cross section of the battery rack according to an embodiment of the present invention.

FIG. 4 is a perspective view of the battery rack according to an embodiment of the present invention.

FIG. 5 is a perspective view of the waterproof casing according to an embodiment of the present invention.

FIG. 6 is a structural diagram of the illuminating circuit according to an embodiment of the present invention.

Reference Numerals

| | | | |
|---|---|---|---|
| 1 | shaft | 2 | handle |
| 3 | magnetic block | 4 | waterproof casing |
| 5 | button switch | 6 | lamp |
| 7 | turnable cap | 8 | transparent cover |
| 9 | pivot | 10 | connecting wire |
| 11 | inserting sheet | 12 | seal ring |
| 13 | plug socket | 14 | negative ring |
| 15 | negative contact spring leaf | 16 | positive electrode |
| 17 | conductive laths of the battery rack | 18 | batteries |
| 19 | negative bottom spring | 20 | fixed base |
| 21 | fixed rivet | 22 | concave chamber |
| A | electric circuit | | |

### DETAILED DESCRIPTION OF THE INVENTION

The embodiments of the present invention will be fully understood from the following description combined with the drawings.

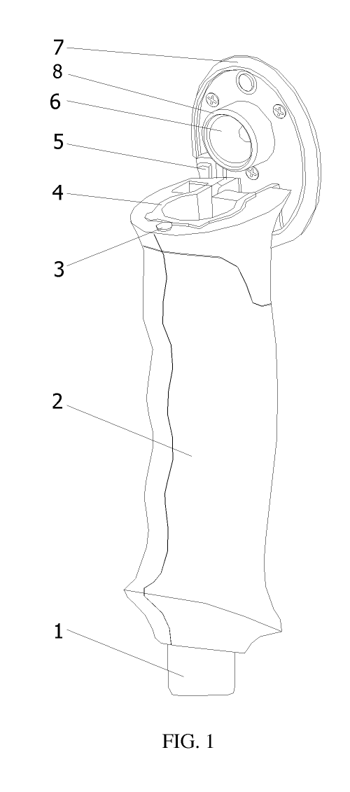

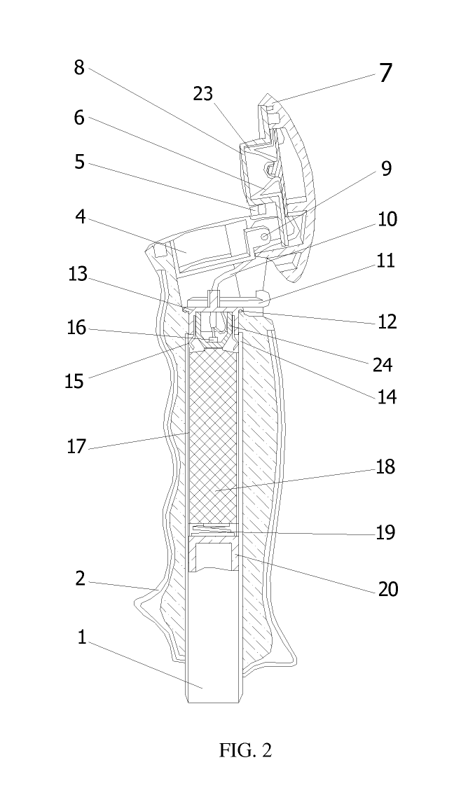

FIG. 1 and FIG. 2 are embodiments of the mountain climbing stick according to the present invention. The mountain climbing stick comprises a shaft 1 and a handle 2. A turnable cap 7, a pivot 9, a lamp 6 with its electric circuit A, a button switch 5 and a battery chamber are arranged at the end of the handle 2; wherein the lamp 6 comprising of a circuit board, a LED and a reflection cup is mounted inside the turnable cap 7, and a waterproof transparent cover 8 used for waterproofing is installed in front of the lamp 6. A waterproof casing 4 with a concave surface is installed at a position where the turnable cap is folded over or buckled with the handle. The concave chamber of the waterproof casing 4 corresponds to a convex shape of the transparent cover. The turnable cap is positioned vertically. A connecting wire 10 of the lamp 6 is serially connected with the button switch (a contact point) from the lower corner of the pivot, and then the lead wire is connected to a plug socket 13 which is installed at the opening of the battery chamber and positioned by an inserting sheet 11. The plug socket 13 has a negative contact spring leaf 15, which is connected with a negative ring 14 of the battery rack when being plugged downward. A magnetic block 3 is used to attract the turnable cap, and a seal ring 12 is arranged in a circular bead along the opening of the battery chamber for a waterproofing purpose. The plug socket also has a positive electrode 16.

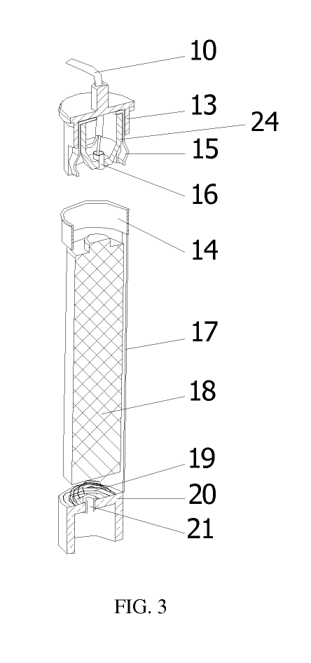

The battery tube or battery rack in the battery chamber comprises of the negative ring 14, a conductive lath for the battery rack 17, a negative bottom spring 19 used also as a shockproof spring (expressed in dashed line in the figure), a fixed rivet 21 (referring to FIG. 3) and a fixed base 20 successively. The negative bottom spring and the negative spring leaf may be integrated together as a tower-shaped spring. The battery 18 is located in the battery chamber. In addition, the conductive laths of the battery rack 17 may be used both for conduction and support purposes.

The battery chamber, on which the plug socket 13 and the battery rack are located, is arranged on the top of the shaft 1, where a section area is maximum.

FIG. 3 and FIG. 4 give a more specific illustration about the position relationship between the plug socket and the battery rack. As shown in FIG. 3, the rivet 21 is used to connect the battery rack into a single part. The battery rack may be installed into the battery chamber with a compact structure. The dual connecting wire 10 on the top of the battery rack is connected to the plug socket 13. One of the dual connecting wires is connected with the negative contact spring leaf 15 on the connection ring, and the other is connected with the positive electrode 16 in the center.

Referring to FIG. 5, there is a concave chamber 22 on the surface of the waterproof casing and a pivot hole for turning the turnable cap is provided on the back of the waterproof casing. The waterproof casing has an outer fringe on the top so as to facilitate waterproofing and turning the turnable cap upwardly. The waterproof casing is withdrawn at its lower back surface to form a locating surface of the turnable cap when turned vertically. The waterproof casing can prevent rain getting into the stick and the water accumulated on the casing may be dumped away or flow out of the casing from the back of the casing. There is no need to worry about the connecting wires getting wet because of the good sealing performance of the connecting terminals.

When using the climbing stick of the present invention, illumination can be initiated by turning the turnable cap 7 upwardly and a straight forward beam will be emitted from the stick. The battery 18 can be replaced when the plug socket 13 is lifted up to give out enough space by pulling out the inserting sheet 11 and turning over the waterproof casing. After replacing the battery, the stick can be returned to the normal state by plugging back the plug socket 13, turning over the waterproof casing 4 downward, and then inserting back the inserting sheet 11, thus the turnable cap returns back to the normal state and the lamp is turned off.

FIG. 6 is a circuit diagram of the illuminating device in the climbing stick. The illuminating device can operate basically with a series circuit comprising of a battery E, a button switch K and a LED. The LED is a lighting load of the illuminating device.

In an embodiment of the present invention according to FIG. 6, the requirement for a short length and single battery can be satisfied. In addition, the luminance of the lamp can be enhanced by adopting a boost circuit to improve the output power. The boost circuit can be found in the electric circuit in FIG. 6.

Referring to FIG. 6, when the button switch K is switched on, the voltage of the power source E will be loaded on to two ends of the capacitor C1. An oscillation circuit with an output voltage of 3.3V will be formed by the power storage of L, the boost IC chip (331) and the diode D1 (IN5819) so as to supply power for the LED D2. The capacitor C2 is an output filter capacitor which is used to enhance the load capacity and stability of the circuit and reduce noise and ripples of the output.

1.-6. (canceled)

7. A mountain climbing stick with an illuminating device, the stick comprising:
a shaft and a handle attached to an end of the shaft, wherein said handle is hollow and including a battery chamber therein;
a turnable cap installed at a distal end of said handle and said turnable cap pivotally connected with said handle by a pivot;
a lamp installed on an inside surface of the turnable cap;
a battery disposed inside said battery chamber such that said lamp is electrically connected with said battery through an electric circuit.

8. The mountain climbing stick with illuminating device according to claim 7, wherein said lamp comprises a circuit board, at least one LED, and a reflection cup mounted inside said turnable cap; a transparent cover used for waterproofing is installed in front of and overlapping said lamp.

9. The mountain climbing stick with illuminating device according to claim 8, wherein a waterproof casing with a concave surface forming a concave chamber is installed at a top surface of the handle at a meeting point where said turnable cap is folded upon the top of the handle; the concave chamber of the waterproof casing corresponding to a convex shape of said transparent cover.

10. The mountain climbing stick with illuminating device according to claim 9, further comprising:
a button switch installed on said turnable cap;
said lamp serially connected with said button switch through a connecting wire from a lower corner of the pivot;
a plug socket and an inserting sheet installed at an opening of said battery chamber;
a battery rack mounted in said battery chamber wherein the connecting wire of said button switch is connected with said plug socket and fixed by said inserting sheet; and
a negative contact spring leaf on said plug socket that is contacted with a negative ring of the battery rack when the plug socket is plugged downward into said battery rack.

11. The mountain climbing stick with illuminating device according to claim 7, wherein said battery chamber is located on a top portion of said shaft.

12. The mountain climbing stick with illuminating device according to claim 7, wherein said electric circuit includes a boost circuit.

13. A mountain climbing stick with an illuminating device, the stick comprising:
a shaft and a handle attached to an end of the shaft, wherein said handle is hollow and including a battery chamber therein;
a turnable cap installed at a distal end of said handle and said turnable cap pivotally connected with said handle by a pivot;
a lamp installed on an inside surface of the turnable cap;
a waterproof casing having a concave chamber installed at a top surface of the handle at a meeting point where said turnable cap is folded upon the top for the handle; and
a battery arranged inside said battery chamber such that said lamp is connected with said battery through an electric circuit.

14. The mountain climbing stick with illuminating device according to claim 13, further comprising a transparent cover having a convex shape for waterproofing the lamp and installed in front of and overlapping said lamp wherein the convex shape of the cover corresponds to the shape of the concave chamber of the casing.

15. The mountain climbing stick with illuminating device according to claim 13, wherein said lamp comprises a circuit board, a LED, and a reflection cup mounted inside said turnable cap.

16. The mountain climbing stick with illuminating device according to claim 15, further comprising
a button switch installed on said turnable cap;
said lamp serially connected with said button switch through a connecting wire from a lower corner of the pivot;
a plug socket and an inserting sheet installed at an opening of said battery chamber;
a battery rack mounted in said battery chamber;
wherein the connecting wire of said button switch is connected with said plug socket and fixed by said inserting sheet; and
a negative contact spring leaf on said plug socket is contacted with a negative ring of the battery rack when the plug socket is plugged downward into said battery rack.

17. The mountain climbing stick with illuminating device according to claim 13, wherein said battery chamber is located on a top portion of said shaft.

18. The mountain climbing stick with illuminating device according to claim 13, wherein said electric circuit includes a boost circuit.

19. The mountain climbing stick with illuminating device according to claim 13, further comprising a magnetic block located on an edge of the top surface of the handle configured to draw in the turnable cap when closing the turnable cap.

20. A mountain climbing stick with an illuminating device, the stick comprising:
a shaft and a handle attached to an end of the shaft, wherein the handle is hollow and including a battery chamber therein;
a turnable cap installed at a distal end of said handle and the turnable cap pivotally connected with the handle by a pivot;
an illuminating device installed on an inside surface of the turnable cap;
a transparent cover having a convex shape for waterproofing the illuminating device and installed on the inside surface of the turnable cap in front of and overlapping said lamp;
a waterproof casing having a concave chamber installed at a top surface of the handle at a meeting point where said turnable cap is folded upon the top for the handle;
a seal ring arranged in a circular bead along a opening of the battery chamber; and
a battery disposed inside said battery chamber such that the illuminating device is connected with the battery through an electric circuit.

21. The mountain climbing stick with illuminating device according to claim 20, wherein the illuminating device comprises a circuit board, a LED, and a reflection cup mounted inside the turnable cap.

22. The mountain stick with illuminating device according to claim 20, wherein said battery chamber is located on a top portion of said shaft.

23. The mountain climbing stick with illuminating device according to claim 20, wherein said electric circuit includes a boost circuit.

24. The mountain climbing stick with illuminating device according to claim 20, further comprising a magnetic block located on an edge of the top surface of the handle configured to draw in the turnable cap when closing the turnable cap.

25. The mountain stick with illuminating device according to claim 20, further comprising:
a button switch installed on the turnable cap; the illuminating device serially connected with the button switch through a connecting wire from a lower corner of the pivot; a plug socket and an inserting sheet installed at an opening of the battery chamber; a battery rack mounted in the battery chamber;
wherein the connecting wire is connected with the plug socket and fixed by the inserting sheet; and a negative contact spring leaf on said plug socket is contacted with a negative ring of the battery rack when the plug socket is plugged downward into the battery rack.

26. The mountain stick with illuminating device according to claim 20, wherein the concave chamber of the waterproof casing rests inside a cavity on the top surface of the handle, the waterproof casing includes an outer fringe to extend and lay along the edge of the casing on the top surface of the handle, providing a further waterproofing seal.
